(19) United States
(12) Patent Application Publication
(10) Pub. No.: US 2015/0115535 A1
(43) Pub. Date: Apr. 30, 2015

(54) SEAL HAVING VARIABLE ELASTIC MODULUS

(71) Applicant: GENERAL ELECTRIC COMPANY, Schenectady, NY (US)

(72) Inventors: Deepak Trivedi, Schenectady, NY (US); Gregory Ronald Gillette, Houston, TX (US); Joseph Alan Incavo, The Woodlands, TX (US)

(73) Assignee: GENERAL ELECTRIC COMPANY, Schenectady, NY (US)

(21) Appl. No.: 14/068,773

(22) Filed: Oct. 31, 2013

(51) Int. Cl. E21B 33/06; F16J 15/02

(52) U.S. Cl. CPC E21B 33/06; F16J 15/022
USPC 277/327; 277/645

(57) ABSTRACT

Embodiments of a seal having a variable elastic modulus are provided herein. In one embodiment, a seal having a variable elastic modulus includes: a body fabricated from an elastomeric material; a channel formed within the body; a tube disposed within the channel, the tube comprising a plurality of interwoven fibers; and an inlet formed in an outer surface of the body, the inlet fluidly coupled to an inner volume of the tube.

### BACKGROUND

The subject matter disclosed herein generally relates to elastomeric seals.

Conventional sealing elements (e.g., seals) utilized to, for example, create water and/or air tight junctions between components are typically fabricated from one or more materials having a predetermined stiffness (e.g., elastic modulus) suitable to accommodate conditions of a particular application. However, the inventors have observed that such conventional seals are effective only in a specific pressure range for which the seal was designed, thereby lacking operational flexibility.

For example, a seal fabricated for use in a high pressure application is typically fabricated from a comparatively stiff material, as compared to a seal fabricated for use in a low pressure application. However, the stiffer material lacks an ability to deform sufficiently to facilitate forming a seal at lower pressures while the softer material exhibits deformation that is too great to facilitate forming a seal at higher pressures.

Therefore, the inventors have provided an improved seal having a variable elastic modulus.

### SUMMARY

Embodiments of a seal having a variable elastic modulus are provided herein.

In one embodiment, a seal having a variable elastic modulus may include: a body fabricated from an elastomeric material; a channel formed within the body; a tube disposed within the channel, the tube comprising a plurality of interwoven fibers; and an inlet formed in an outer surface of the body, the inlet fluidly coupled to an inner volume of the tube.

In one embodiment, an o-ring having a variable elastic modulus may include: a substantially circular body fabricated from an elastomeric material; a channel formed within the body; a tube disposed within the channel, the tube comprising a plurality of interwoven fibers; and an inlet formed in an outer surface of the body, the inlet fluidly coupled to an inner volume of the tube.

In one embodiment, a packer element for a zonal isolation device or blowout preventer may include: a semicircular body fabricated from an elastomeric material, the body having a first flange and a second flange respectively coupled to a first end and a second end of the body, wherein the first flange and the second flange are configured to interface with one or more components of the zonal isolation device or blowout preventer; a channel formed within the body, the channel having a first end and a second end respectively disposed proximate the first end and the second end of the body; a tube disposed within the channel, the tube comprising a plurality of interwoven fibers; and an inlet formed in an outer surface of the body, the inlet fluidly coupled to an inner volume of the tube.

The foregoing and other features of embodiments of the present invention will be further understood with reference to the drawings and detailed description.

### DESCRIPTION OF THE FIGURES

Embodiments of the present invention, briefly summarized above and discussed in greater detail below, can be understood by reference to the illustrative embodiments of the invention depicted in the appended drawings. It is to be noted, however, that the appended drawings illustrate only typical embodiments of the invention and are therefore not to be considered limiting in scope, for the invention may admit to other equally effective embodiments.

FIG. 1 is a cross sectional view of a seal having a variable elastic modulus in accordance with some embodiments of the present invention.

FIG. 2 is a cross sectional view of a portion of a seal having a variable elastic modulus in accordance with some embodiments of the present invention.

FIG. 3 is a side view of a portion of a seal having a variable elastic modulus in accordance with some embodiments of the present invention.

FIG. 4 is a cross sectional view of a seal having a variable elastic modulus in accordance with some embodiments of the present invention.

FIG. 5 is a cross sectional view of a seal having a variable elastic modulus in use in accordance with some embodiments of the present invention.

To facilitate understanding, identical reference numbers have been used, where possible, to designate identical elements that are common to the figures. The figures are not drawn to scale and may be simplified for clarity. It is contemplated that elements and features of one embodiment may be beneficially incorporated in other embodiments without further recitation.

### DETAILED DESCRIPTION

Embodiments of a seal having a variable elastic modulus are disclosed herein. The inventive seal advantageously provides a tube having a plurality of interwoven fibers disposed within a body of the seal that allows an elastic modulus of the seal to be varied as a pressure within the tube is changed. By varying the elastic modulus of the seal, the seal may be functional in a wider range of operating conditions (e.g., temperature and/or pressure) as compared to conventionally utilized seals, thereby providing a seal having improved flexibility with respect to a range of applications.

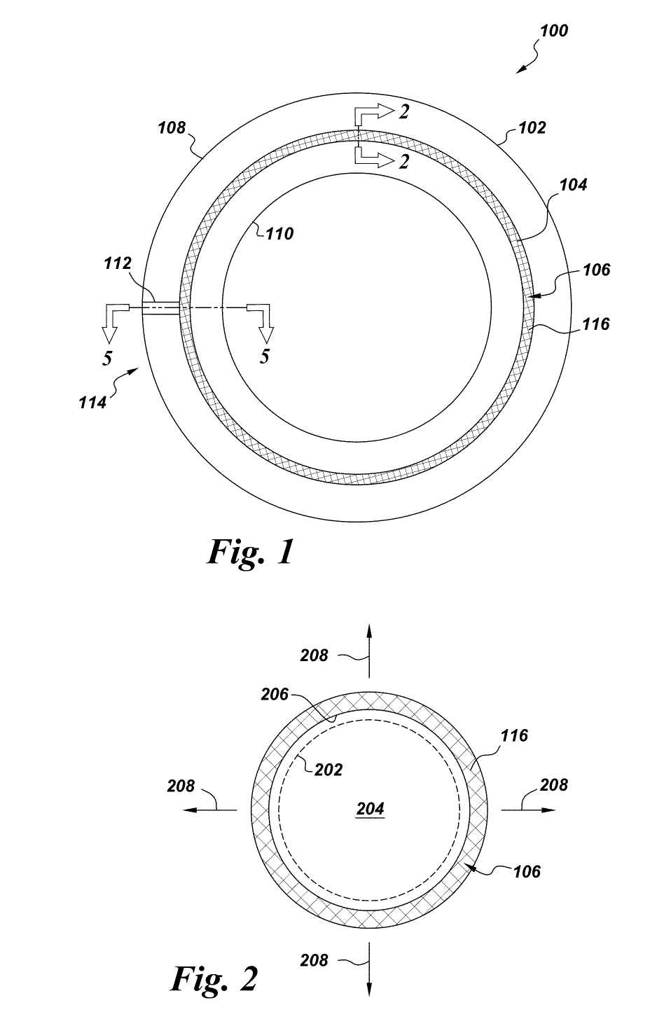

FIG. 1 is a cross sectional view of a seal 100 having a variable elastic modulus in accordance with some embodiments of the present invention. In one embodiment, the seal 100 generally comprises a body 102, a channel 104 formed in the body 102 and tube 106 disposed within the channel 104.

The body 102 may comprise any shape suitable to form a seal between components in a desired application and may be dependent on the size and/or shape of the components. For example, in one embodiment, the body 102 may be substantially ring shaped (e.g., in applications where the seal 100 may be utilized as an o-ring), having an inner diameter 110 and an outer diameter 108 such as shown in FIG. 1. Alternatively, in one embodiment, the body 102 may have a substantially semicircular shape (e.g., in applications where the seal 100 may be utilized as a packer element for a zonal isolation device or blow out preventer (BOP), such as a fixed bore ram, annual packer, variable ram packer (Hydril), or the like), such as described below with respect to FIG. 4.

The body 102 may be fabricated from any elastomeric material that is compatible with process conditions of a desired application. For example, in one embodiment, the body 102 may be fabricated from a polymer, such as a rubber compound, silicone or the like. In embodiments where the body 102 is fabricated from a rubber compound, the compound may be based on any suitable rubber compound, for example, such as a compound based on nitrile butadiene rubber, hydrogenated butadiene rubber, natural rubber, butyl rubber, fluorocarbon rubber, perfluorinated rubber, silicone rubber, polyurethane rubber, styrene butadiene rubber, butadiene rubber, polychloroprene rubber, epichlorohydrin rubber, silicone rubber, ethylenpropylene diene rubber, polyacrylate rubber, or the like. The rubber compound may be selected at least in part based on properties that may be suitable to accommodate a particular application. For example, the inventors have observed that butyl rubber may have a sufficiently low permeability to function as a barrier. In another example, nitrile butadiene rubber, hydrogenated butadiene rubber, fluorocarbon rubber, perfluorinated rubber, polychloroprene rubber and epichlorohydrin rubber may provide oil and/or chemical resistance. In another example, fluorocarbon rubber, perfluorinated rubber, silicone rubber and hydrogenated butadiene rubber may be beneficial in high temperature applications.

In one embodiment, an inlet 112 may be formed in an outer surface 114 of the body 102, extending at least partially through the body 102, such as shown in FIG. 1. When present, the inlet 112 may be fluidly coupled to the channel 104 and/or to an inner volume of the tube 106 (described below with respect to FIG. 2).

The channel 104 may be disposed in any position within the body 102 suitable to facilitate varying the elastic modulus of the seal 100 throughout at least a portion of the seal 100. For example, in embodiments where the body 102 is substantially ring shaped, the channel 104 may also ring shaped and disposed such that the channel 104 is concentric with the body 102, such as shown in FIG. 1. Alternatively, in one embodiment, the channel 104 may be disposed within a portion of the body 102, such as described below with respect to FIG. 4. Although shown in the figures as a having a shape that is substantially similar to the body 102, it is to be understood that the channel 104 may be any shape suitable to provide a desired variable elastic modulus throughout at least a portion of the seal 100 and may be independent of the overall shape of the body 102.

The tube 106 is disposed within the channel 104 and generally comprises a plurality of interwoven fibers 116. The fibers of the plurality of interwoven fibers 116 may be fabricated from any substantially inelastic material. For example, in one embodiment, the fibers may be fabricated from a polymer based material, such as nylon, polyester, cotton, rayon or the like.

Referring to FIG. 2, the tube 106 generally defines an inner volume 204. In operation, an increase or decrease in pressure within the inner volume 204 of the tube 106 respectively increases or decreases the elastic modulus (stiffness) of the tube 106, thereby increasing or decreasing the stiffness of the seal (seal 100). For example, as the pressure within the inner volume 204 of the tube 106 is increased, an outward pressure (indicated by arrows 208) is applied to the tube 106, thereby causing the tube 106 to expand radially and, due to the inelastic properties of the plurality of fibers 116, decrease longitudinally. As the pressure further increases, the plurality of fibers 116 interlock at a predetermined angle (e.g., the “weave angle”) thus preventing a further radial expansion and longitudinal contraction of the tube 106, thereby causing an increase in tension of the plurality of fibers 116. As the tension of the plurality of fibers 116 increases, the stiffness of the tube 106, and therefore, the stiffness of the seal (e.g., seal 100 of FIG. 1) increases.

The pressure within the inner volume 204 of the tube 106 may be increased or decreased via any manner suitable to increase or decrease the pressure to a desired magnitude in accordance with a particular application. For example, in one embodiment, the pressure may be varied via a provision or removal of a fluid, for example a non-compressible or hydraulic fluid (e.g., water, oils, alcohols, esters, silicones, or the like) to the inner volume 204 of the tube 106. As used herein, the term “non-compressible” means a fluid having a bulk modulus of about 100,000 psi or greater. However, it is to be noted that a compressible fluid with a comparatively lower bulk modulus (e.g., air, nitrogen, or the like) may also be utilized and may be dependent on the particular application. Alternatively, or in combination, in one embodiment, the pressure may be varied via an increase or decrease of pressure applied to a volume of the non-compressible or hydraulic fluid disposed within the inner volume 204 of the tube 106.

The stiffness of the tube 106 (and, therefore, the seal) may be increased to any stiffness suitable to accommodate a desired application. For example, in one embodiment, the elastic modulus of the tube 106 may be increased by up to 2 orders of magnitude, for example, from about 1 MPa to about 100 MPa.

In one embodiment, the tube 106 may comprise an inner tube 202 disposed within the inner volume 204 of the tube 106 and proximate an inner surface 206 of the tube 106. When present, the inner tube 202 may function to prevent leakage of the non-compressible or hydraulic fluid from the tube 106, for example, in embodiments where the tube 106 is porous. In addition, the inner tube 202 may prevent exposure of the plurality of fibers 116 to the non-compressible or hydraulic fluid disposed within the inner volume 204 of the tube 106, thereby preventing or reducing degradation of the plurality of fibers 116 that would otherwise be caused by exposure of the plurality of fibers 116 to the non-compressible or hydraulic fluid. The inner tube 202 may be fabricated from any elastic material that is compatible or non-reactive with the non-compressible or hydraulic fluid and may be dependent on a desired application. For example, in one embodiment, the inner tube 202 may be fabricated from a polymer, such as a rubber compound, silicone or the like.

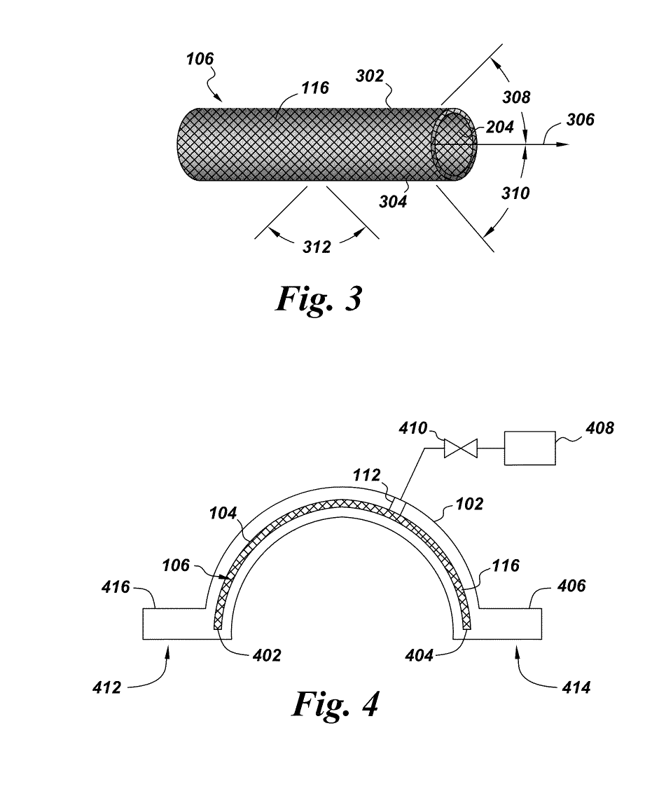

The plurality of interwoven fibers 116 may be configured in any manner suitable to facilitate the increase or decrease in the elastic modulus of the seal as described above. For example, referring to FIG. 3, in one embodiment, the plurality of fibers 116 are arranged such that an angle 308 of a first group of fibers 302 with respect to a longitudinal axis 306 of the tube 106 is substantially equal and substantially opposite to an angle 310 of a second group of fibers 304 with respect to the longitudinal axis 306 of the tube 106. In addition, the plurality of interwoven fibers 116 may be arranged such that, upon pressurization of the inner volume 204 of the tube 106, the first group of fibers 302 and the second group of fibers 304 interlock at a predetermined angle 312 with respect to one another (e.g., the “weave angle” discussed above). For example, in one embodiment, the first group of fibers 302 and the second group of fibers 304 may interlock at an angle 312 of about 50 degrees to about 60 degrees, or about 54° 44′ upon pressurization of the tube 106. The inventors have observed that the interlock angle may be dependent on frictional forces, or lack thereof.

Although described above as having a circular shape, the body 102 and/or tube 106 may have any shape suitable to accommodate for a desired application. For example, in one embodiment, such as where the seal 100 is utilized as a packer element for a zonal isolation device or blow out preventer (BOP) (e.g., a fixed bore ram, annual packer, variable ram packer (Hydril), or the like), the body 102 and tube 106 may have a substantially semicircular shape, such as shown in FIG. 4. In such embodiments, the body 106 may comprise one or more flanged ends (first flange 406 and second flange 416 coupled to a respective first end 414 and second end 412 shown in the figure) configured to interface with components of the zonal isolation device or blowout preventer. In addition, the tube 106 may be configured to provide a variable modulus throughout a portion of the body 102 that would interface with a surface of a pipe, tube, bore, or the like. For example, the tube 106 may be sized such that a first end 404 of the tube 106 extends proximate the first end 414 of the body 102 and a second end 402 of the tube 106 extends proximate the second end 412 of the body 102.

In one embodiment, a pressure controller 408 may be fluidly coupled to the inlet 112 to facilitate controlling the pressure within the tube 106 to vary the elastic modulus of the seal (e.g., as described above). The pressure controller 408 may comprise any components suitable to vary the pressure in such a manner. For example, in one embodiment, the pressure controller 408 may comprise a fluid source (e.g., the hydraulic or non-compressible fluid described above) configured to facilitate the provision or reduction of fluid pressure within the tube 106, as described above. Alternatively, or in combination, in one embodiment, the pressure controller 408 may comprise a mechanical actuator configured to apply pressure to the fluid disposed within the tube 106 to facilitate an increase of pressure within the tube 106. In one embodiment, a valve 410 may be fluidly coupled to the inlet 112 to selectively open or seal the inlet 112.

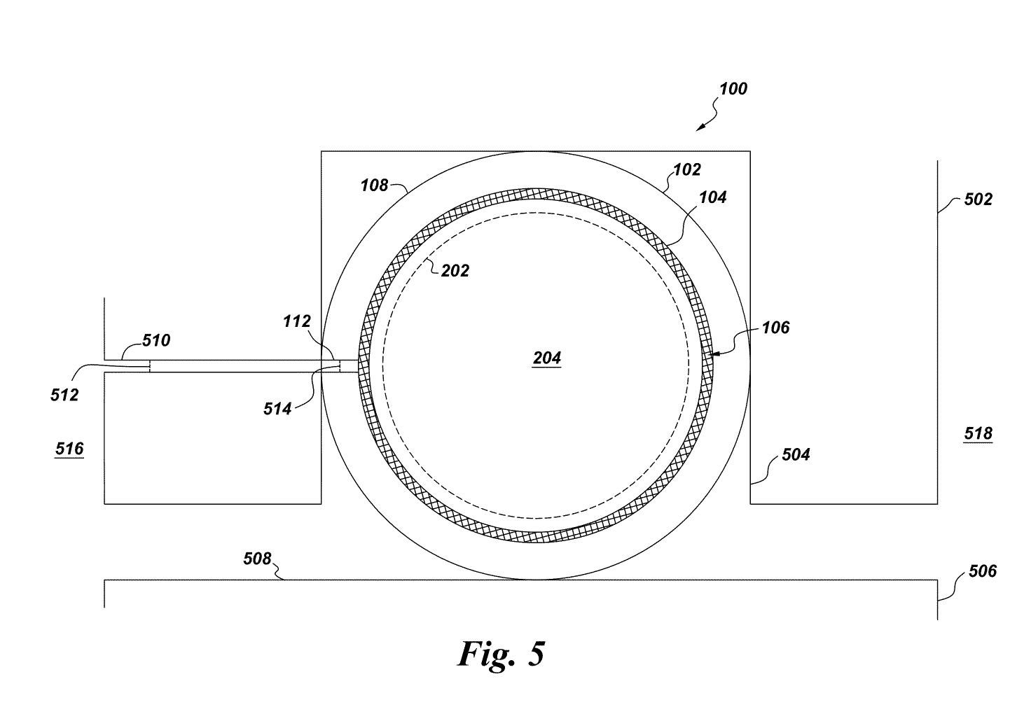

Referring to FIG. 5, in an exemplary operation of one embodiment of the seal 100, the seal 100 may be disposed between a first plate 502 and a second plate 506 to isolate an area of high pressure (a high pressure side 516) from an area of low pressure (a low pressure side 518). In such an embodiment, the seal 100 may be disposed in a channel 504 formed in the first plate 502. The seal 100 may be positioned such that the inlet 112 of the body 102 is disposed proximate a through hole 510 formed in a portion of the first plate 502 to fluidly couple the inner volume 204 of the tube 106 to the high pressure side 516. In operation, as a pressure in the high pressure side 516 increases, the pressure within the inner volume 204 of the tube 106 increases, thereby causing an outward pressure of the seal 100 against the channel 504 and a surface 508 of the second plate 506 and an increase in stiffness of the seal 100, thus forming a seal between the first plate 502 and the second plate 506.

In one embodiment, one or more membranes may be disposed in the through hole 510 and/or inlet 112 (first membrane 512 disposed in the through hole 510 and second membrane 514 disposed in the inlet 112 shown) and positioned such that a surface of the membrane is substantially perpendicular with a longitudinal axis of the inlet 112. When present, the one or more membranes facilitate a transfer of pressure from the high pressure side 516 to the inner volume 204 of the tube 106 while isolating a fluid disposed in each of the high pressure side 516 and the inner volume 204, thereby allowing different fluids and/or environments to be present in the inner volume 204 of the tube 106 and the high pressure side 516.

Thus, embodiments of a seal having a variable elastic modulus have been provided herein. In at least one embodiment, the inventive seal may advantageously be functional in a wider range of operating conditions (e.g., temperature and/or pressure) as compared to conventionally utilized seals, thereby providing a seal having improved flexibility with respect to a range of applications.

Ranges disclosed herein are inclusive and combinable (e.g., ranges of “an angle of about 50 degrees to about 60 degrees”, is inclusive of the endpoints and all intermediate values of the ranges of “about 50 degrees to about 60 degrees,” etc.). “Combination” is inclusive of blends, mixtures, alloys, reaction products, and the like. Furthermore, the terms “first,” “second,” and the like, herein do not denote any order, quantity, or importance, but rather are used to distinguish one element from another, and the terms “a” and “an” herein do not denote a limitation of quantity, but rather denote the presence of at least one of the referenced item. The modifier “about” used in connection with a quantity is inclusive of the state value and has the meaning dictated by context, (e.g., includes the degree of error associated with measurement of the particular quantity). The suffix “(s)” as used herein is intended to include both the singular and the plural of the term that it modifies, thereby including one or more of that term (e.g., the colorant(s) includes one or more colorants). Reference throughout the specification to “one embodiment”, “another embodiment”, “an embodiment”, and so forth, means that a particular element (e.g., feature, structure, and/or characteristic) described in connection with the embodiment is included in at least one embodiment described herein, and may or may not be present in other embodiments. In addition, it is to be understood that the described elements may be combined in any suitable manner in the various embodiments.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from essential scope thereof. Therefore, it is intended that the invention not be limited to the particular embodiment disclosed as the best mode contemplated for carrying out this invention, but that the invention will include all embodiments falling within the scope of the appended claims.

1. A seal having a variable elastic modulus, comprising:
a body fabricated from an elastomeric material;
a channel formed within the body;
a tube disposed within the channel, the tube comprising a plurality of interwoven fibers; and
an inlet formed in an outer surface of the body, the inlet fluidly coupled to an inner volume of the tube.

2. The seal of claim 1, wherein the tube further comprises:
an elastic inner tube disposed within the tube.

3. The seal of claim 1, further comprising:
a valve fluidly coupled to the inlet.

4. The seal of claim 1, further comprising:
a pressure controller fluidly coupled to the inlet.

5. The seal of claim 4, wherein the pressure controller comprises at least one of a fluid source or an actuator.

6. The seal of claim 1, further comprising:
one or more membranes disposed within the inlet and positioned such that a surface of the membrane is substantially perpendicular with a longitudinal axis of the inlet.

7. The seal of claim 6, further comprising:
a non-compressible fluid disposed within the inner volume of the tube.

8. The seal of claim 1, wherein the fibers are substantially inextensible.

9. The seal of claim 1, wherein the plurality of fibers are arranged such that an angle of the first group of fibers with respect to a longitudinal axis of the tube is substantially equal and substantially opposite to an angle of the second group of fibers with respect to the longitudinal axis of the tube.

10. The seal of claim 1, wherein the elastomeric material is a polymer.

11. The seal of claim 10, wherein the polymer is a rubber compound.

12. The seal of claim 1, wherein the seal is one of an o-ring or semicircular packer element for a zonal isolation device or a blowout preventer.

13. An o-ring having a variable elastic modulus, comprising:
a substantially circular body fabricated from an elastomeric material;
a channel formed within the body;
a tube disposed within the channel, the tube comprising a plurality of interwoven fibers; and
an inlet formed in an outer surface of the body, the inlet fluidly coupled to an inner volume of the tube.

14. The o-ring of claim 13, wherein the tube further comprises:
an elastic inner tube disposed within the tube.

15. The o-ring of claim 13, wherein the fibers are substantially inextensible.

16. The o-ring of claim 13, wherein the plurality of fibers are arranged such that an angle of the first group of fibers with respect to a longitudinal axis of the tube is substantially equal and substantially opposite to an angle of the second group of fibers with respect to the longitudinal axis of the tube.

17. A packer element for a zonal isolation device or blowout preventer, comprising:
a semicircular body fabricated from an elastomeric material, the body having a first flange and a second flange respectively coupled to a first end and a second end of the body, wherein the first flange and the second flange are configured to interface with one or more components of the zonal isolation device or blowout preventer;
a channel formed within the body, the channel having a first end and a second end respectively disposed proximate the first end and the second end of the body;
a tube disposed within the channel, the tube comprising a plurality of interwoven fibers; and
an inlet formed in an outer surface of the body, the inlet fluidly coupled to an inner volume of the tube.

18. The packer element of claim 17, wherein the tube further comprises:
an elastic inner tube disposed within the tube.

19. The packer element of claim 17, wherein the fibers are substantially inextensible.

20. The packer element of claim 17, wherein the plurality of fibers are arranged such that an angle of the first group of fibers with respect to a longitudinal axis of the tube is substantially equal and substantially opposite to an angle of the second group of fibers with respect to the longitudinal axis of the tube.
